(19) United States
(12) Patent Application Publication
(10) Pub. No.: US 2007/0282683 A1
(43) Pub. Date: Dec. 6, 2007

(54) Targeted marketing communication system

(76) Inventor: Mohd N. Alkassmi, Chester Springs, PA (US)

Correspondence Address: COURTNEY STANIFORD & GREGORY LLP, P.O. BOX 9686, SAN JOSE, CA, 95157, US

(21) Appl. No.: 11/714,483

(22) Filed: Mar. 5, 2007

Related U.S. Application Data
(60) Provisional application No. 60/810,336, filed on Jun. 2, 2006.

(51) Int. Cl. G06Q 30/00

(52) U.S. Cl. 705/14

(57) ABSTRACT

Targeted marketing communication systems (TMCSs) and corresponding methods are described that enable ongoing focused marketing communication between participating vendors and participating subscribers. The TMCS rewards a participating subscriber with points for reporting activity data (e.g., recurring subscriber activity, automobile mileage, cellular telephone minutes, long-distance telephone minutes, etc.) and for undertaking additional tasks such as completing surveys and questionnaires. The points are redeemable for discounts on goods and services provided by participating vendors. The locus of interaction between vendor and subscriber is a TMCS interface. The TMCS provides vendors with the opportunity of developing long-term exposure to brands and goods and services resulting in higher levels of subscriber loyalty and purchasing. The TMCS provides subscribers with the opportunity to acquire greater knowledge of vendor goods and services and secure discounts on such goods and services through the TMCS.

### RELATED APPLICATION

This application claims the benefit of U.S. Patent Application No. 60/810,336, filed Jun. 2, 2006.

### TECHNICAL FIELD

The disclosure herein relates generally to marketing communication systems and methods.

### BACKGROUND

Historically the vast majority of marketing activity on the Internet has consisted of vendors placing short easy-to-read text or text plus image advertisements in front of people. These advertisements were presented using either of sidebars or pop-ups triggered by the appearance of one or more key words in an online search string for example. Such advertisements are essentially intrusions into the workspace of the individuals concerned and are equivalent to billboards or newspaper placements insofar as they are designed to convey a simple message quickly with little reference to the preferences of those experiencing the intrusions. Such marketing techniques do not allow vendors to develop ongoing relationships with their individual customers that are based on more than simple awareness and brand identification. As Internet advertising becomes a saturated field and click-through fraud becomes increasingly prevalent it is apparent that there is a need to move to a more results-oriented methods of interacting with actual and potential customers. Consequently, there is a need for systems and methods that allow vendors to enter into extended interactions with self-selecting prospective customers whereby the interactions allow the vendors to convey detailed information and offerings of products and services to those prospective consumers who are most likely to respond favorably to such offers.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

FIG. 1 is a block diagram of the targeted marketing communication system (TMCS), under an embodiment.

FIG. 2 is a flow diagram for targeted marketing communication using the TMCS, under an embodiment.

FIG. 3 is a flow diagram illustrating a process implemented on a web site and involving an initial user who is also a prospective member, according to an embodiment.

FIG. 4 is a flow diagram illustrating a process implemented on the web site and involving an initial user who is a vendor who desires to be a member, according to an embodiment.

FIG. 5 is a flow diagram illustrating a process implemented on the web site and involving an initial user who is a consumer who desires to be a member, according to an embodiment.

FIG. 6A is a flow diagram illustrating a process implemented on the web site and involving a consumer user, according to an embodiment.

FIG. 6B is a flow diagram illustrating a continued process implemented on the web site and involving a consumer user, according to an embodiment.

FIG. 6C is a flow diagram illustrating a continued process implemented on the web site and involving a consumer user, according to an embodiment.

FIG. 7 is a flow diagram illustrating a process implemented on the web site and involving a vendor user, according to an embodiment.

FIG. 8 is a representation of a TMCS interface, under an embodiment.

### DETAILED DESCRIPTION

Targeted marketing communication systems and methods are described that enable ongoing focused marketing communication between participating vendors and participating subscribers. The targeted marketing communication systems and methods, collectively referred to herein as the targeted marketing communication system (TMCS), reward a participating subscriber or user with points for reporting activity data (e.g., recurring subscriber activity, automobile mileage, cellular telephone minutes, long-distance telephone minutes, etc.) and/or for undertaking additional tasks such as completing surveys and questionnaires. The points are redeemable for discounts on goods and services provided by participating vendors. The locus of interaction between vendor and subscriber is a customized interface. The TMCS provides vendors with the opportunity of developing long-term exposure to brands and goods and services resulting in higher levels of subscriber loyalty and purchasing. The TMCS provides subscribers with the opportunity to acquire greater knowledge of vendor's goods and services and secure discounts on such goods and services through the TMCS.

The TMCS described herein provides companies (vendors) with an activity data-based affinity club by which the companies can target marketing communications to individual consumers (subscribers). The TMCS thus allows companies to develop, over an extended period of time, focused relationships with the individual consumers based on brand awareness, ancillary information, and a variety of offers including but not limited to discounts on the standard retail price of selected items and services for example.

Consumers subscribing to the TMCS interface or website described herein gain benefit by converting activity data (e.g., recurring subscriber activity, automobile mileage, cellular telephone minutes, long-distance telephone minutes, etc.) into points that are redeemable against products and services provided by the member companies (vendors) of the TMCS. The TMCS vendors benefit from enhanced long-term exposure to a large number of potential customers because the targeted exposure provides them with the opportunity to enter into more sophisticated marketing relationships than permitted by more transient means of communication. The TMCS therefore creates significant benefits for both consumers and the vendors that serve them, through the mechanism of an activity-based affinity system.

The term “vendor” as used herein includes any corporation, business, or sole proprietor engaged in offering products or services. A vendor includes, for example, a national and/or regional retail organization in one or more categories including home goods, electronics, office supplies, sporting goods, petroleum, computer equipment, transportation, airlines, car rental, automotive manufacturer, automotive dealer, automotive repair, insurance, home furnishings, and home builders, to name a few. The term “subscriber” as used herein includes any individual registered or interested in registering to use the TMCS.

In the following description, numerous specific details are introduced to provide a thorough understanding of, and enabling description for, embodiments of the TMCS. One skilled in the relevant art, however, will recognize that these embodiments can be practiced without one or more of the specific details, and/or with other components and systems, to name a few. In other instances, well-known structures or operations are not shown, or are not described in detail, to avoid obscuring aspects of the disclosed embodiments.

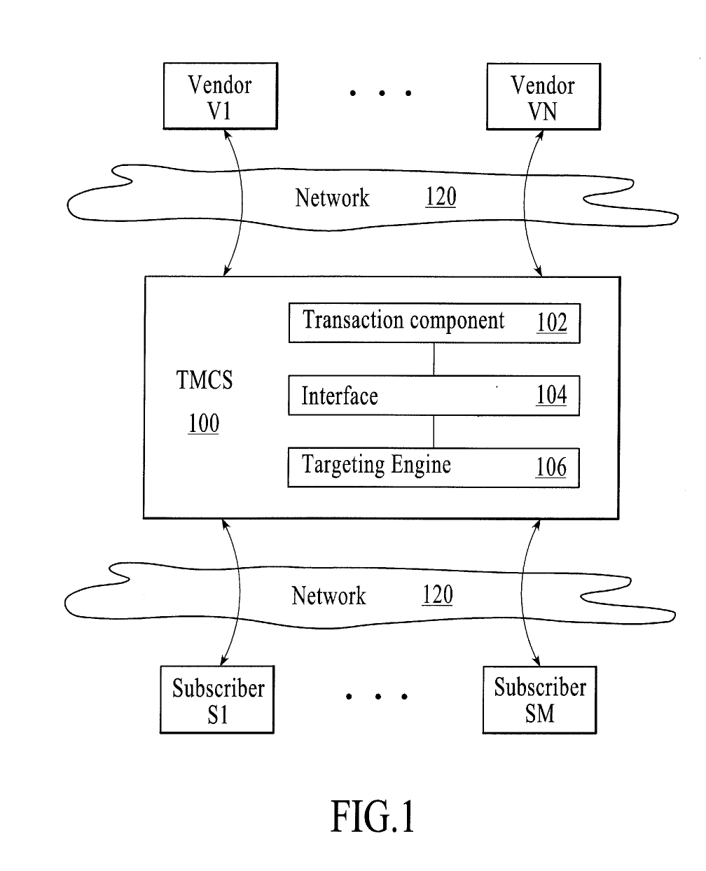

FIG. 1 is a block diagram of the targeted marketing communication system (TMCS) 100, under an embodiment. The TMCS 100 includes one or more of a transaction component 102, an interface 104, and a targeting engine 106 coupled and configured as described herein. The TMCS 100 is hosted on or running under at least one server or other processor-based system (not shown) to which the TMCS 100 is coupled or connected. Components 102-106 of the TMCS 100 can reside together on a single processor-based system; components 102-106 or functions of the components 102-106 can also be distributed among two or more processor-based systems located at the same and/or different locations. Components 102-106 of the TMCS 100 are coupled to client devices of one or more subscribers S1-SM (where “M” represents zero or any positive integer number) and numerous vendors V1-VN (where “N” represents zero or any positive integer number) via one or more networks 120.

The TMCS interface 104 (also referred to as the “interface”) is configured to transfer communications between one or more of the subscribers S1-SM and the vendors V1-VN. The interface 104 of an embodiment includes an Internet website, but is not so limited. The interface 104 of alternative embodiments can include, for example, wireless telemetric relay of activity data from one or more client devices of the subscriber to the transaction component, integration with the subscriber's in-vehicle navigation system, and voice-activated updating of subscriber data through a telephone or other communication devices to name a few.

The transaction component 102 is configured to receive registration data of at least one subscriber S1-SM. The transaction component 102 is also configured to provide vendor information of one or more of the vendors V1-VN to the subscriber S1-SM. Measured activity data of the subscriber S1-SM is received by the transaction component 102 which, in response, assigns points to the measured activity and tracks points accumulated by the subscriber S1-SM. Further, the transaction component 102 is configured to assign a monetary value to the points and to support transactions involving use of the points as described in detail below.

In operation, vendor V1-VN participation in the TMCS 100 includes participation under a variety of methods including, but not limited to, direct coupling or connection of vendor purchasing and inventory management systems to the TMCS 100, indirect coupling or connection of vendor systems via proxy servers to the TMCS 100, and replication on the TMCS website (interface 104) of some or all of vendor corporate website content. Vendors V1-VN are solicited for participation in the TMCS 100 through one or more of direct sales campaigns, marketing campaigns, vendor referral campaigns, and other solicitation mechanisms as appropriate to the vendor, to name a few.

Components of the TMCS 100 of an embodiment include and/or run under and/or in association with a processing system of a client device as described above. The processing system or client device includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among portable computers (PCs), cellular telephones, personal digital assistants (PDAs), portable computing devices, and portable communication devices, but is not so limited. The processing system can include components within a larger computer system.

The processing system of an embodiment includes at least one processor and at least one memory. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the TMCS 100, and/or provided by some combination of algorithms. The methods included in the TMCS 100 can be implemented in software algorithm(s), firmware, hardware, and any combination of software, firmware, and hardware.

Components of the TMCS 100 can be located together or in separate locations. Communication paths couple the TMCS components 102-106 and include any medium for communicating or transferring files among the components. The communication paths include one or more of wireless connections, wired connections, and hybrid wireless/wired connections. The communication paths also include couplings or connections to the networks 120, wherein the networks include local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages. While the TMCS 100 is described herein in terms of an application to the World Wide Web (also referred to as the “web”) and Internet it is understood that the TMCS 100 can be used on any electronic system or under any network type or communication protocol.

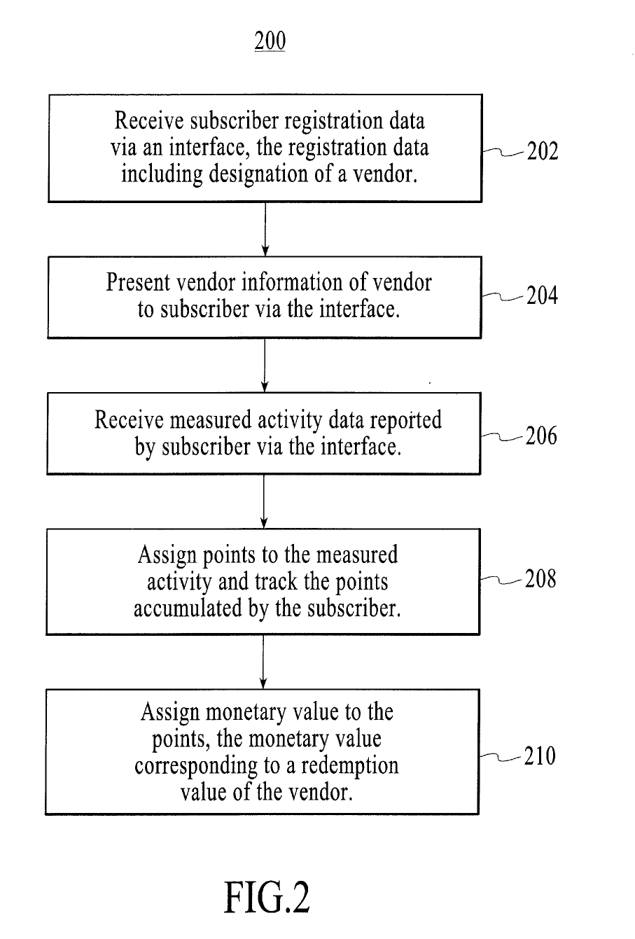

Components 102-106 of the TMCS 100 of an embodiment are configured to support targeted marketing communication where, for example, FIG. 2 is a flow diagram for targeted marketing communication 200 using the TMCS, under an embodiment. The targeted marketing communication 200 of an embodiment generally receives 202 registration data of a subscriber via an interface. The registration data includes a designation or selection of at least one vendor from a number of available vendors. Vendor information of a designated vendor is presented 204 to the subscriber via the interface. The vendor information includes for example advertisements and directed marketing communication. Presentation 204 of the vendor information provides regular metered exposure to the subscriber by the vendor.

Measured activity data is reported by the subscriber and received 206 via the interface. The measured activity data includes data of quantifiable or measurable recurring activities periodically reported by the subscriber. For example, the measured activity data includes automobile mileage driven during a period of time. As another example, the measured activity data includes cellular telephone minutes used during a period of time. As yet another example, the measured activity data includes long-distance telephone minutes used during a period of time. The TMCS assigns 208 points to the measured activity, and tracks points accumulated by the subscriber over specified periods of time or activity. Additionally, the TMCS assigns points to periodic visits by the subscriber to one or more of the interface, a web page of the vendor, a web site of the vendor, and a web page affiliated with the vendor.

The targeted marketing communication 200 of an embodiment assigns 210 a monetary value to the points. The assigned monetary value corresponds to a redemption value of one or more vendors designated by the subscriber. The targeted marketing communication 200 is configured to present via the interface an offer for goods and/or services to a subscriber when the points accumulated by the subscriber reach a threshold value. Discount information of goods and/or services can also be presented to the subscriber via the interface, and the discount information is also determined using information of the accumulated points. The discount information can be adjusted according to accumulated points, changes or fluctuations in accumulated points, and/or goods and/or services for which points can be redeemed. The targeted marketing communication 200 enables transactions via the interface by which a subscriber redeems accumulated points for a product and/or service of a vendor. Arbitrage transactions are also enabled by which a subscriber having a number of accumulated points negotiates for trade or sale with another subscriber having accumulated points.

The TMCS described herein enables vendors to track outcomes directly in the form of purchases of products and services by consumers rather than relying on indirect indications of interest such as page views. Because subscribers to the TMCS convert their reported activity data (e.g., automobile miles, etc.) into points and then redeem these points against specific products and services from specific vendors, there is no ambiguity around whether or not a particular subscriber ultimately made a purchase. Thus, marketing expenditure on the part of the participating vendors can be directly linked to resulting revenues. This is in contrast to conventional techniques under which vendors pay to insert advertisements on selected web pages and pay each time a consumer activates the link (known as a click-through) to reach a page that contains one or more advertisements or links to additional web pages on the vendor's home website. Vendors attempt to estimate how many click-throughs will ultimately result in a sale and also attempt to estimate the average value of such sales. The resulting imprecision inherent in this conventional approach leads to lack of clarity regarding the effectiveness of utilizing the Internet as a medium for advertising. The TMCS however completely eliminates the ambiguity of conventional techniques and enables corporations to determine their optimal level of TMCS-based Internet marketing expenditure for a given revenue target.

In addition to providing vendors with a fraud-proof method of establishing an ongoing relationship with potential customers, the TMCS also provides a more targeted prospect base. Conventional techniques of matching advertisements to potential customers rely on algorithms that examine key words and phrases in search strings that are entered into search engines provided by third parties. Based on the mechanical weighting of these search terms and the price paid by individual vendors to ensure prominence, advertisements are then presented on the web page of the person who has entered the search term. Although such algorithms are the subject of constant refinement it remains the case that a great many advertisements are presented to people who will have no interest in them. This is especially relevant considering recent attempts to automatically place advertisements into emails and blogs based on similar weighting of key words and phrases. These incorrectly presented advertisements represent a very significant waste of opportunity and are potentially irritating to consumers. The TMCS, conversely, does not rely on algorithmic selection to guess whether a consumer is potentially interested in the offer in question but instead enables its subscribers to self-select those vendors from whom they are most interested in receiving communications about goods and services. This will result in a much higher conversion ratio from prospect to customer and ensure that economic opportunities are not wasted through imprecise targeting of vendor-consumer interactions.

Additionally, in addition to creating redeemable points through recurring reportable activities (e.g., the act of driving an automobile, etc.), TMCS subscribers are offered opportunities to earn more points through other activities like participating in online surveys, viewing specific advertisements, and playing branded interactive games to name a few. Each additional point-earning opportunity provides specific vendors with the opportunity to develop closer relationships with selected subscribers, including the opportunity to gather information including detailed demographic information, past purchase behavior, customer feedback on goods and services, and other information that enables participating vendors to refine their marketing activities.

The TMCS also enables subscribers to enter into arbitrage transactions with other subscribers so that miles or points can be traded between individuals for the mutual benefit of the participating subscribers. Arbitrage transactions as used herein generally includes transactions involving the simultaneous or near simultaneous sale or exchange of TMCS points in different markets to profit from unequal prices. Such arbitrage opportunities are present because different vendors can elect to allow point redemption at different monetary values. Thus, a subscriber wishing to reach a point threshold for redemption against the price of a new house might elect to trade cash for points with a second subscriber who wants to purchase a digital camera. In the case of this example, the value of TMCS points for the first subscriber is significantly greater than the value assumed by the second subscriber because the two vendors in question redeem points at significantly different point-to-dollar ratios, so both subscribers can benefit from the transaction.

The targeted marketing communication described herein, when using automobile mileage as an example, turns each subscriber's vehicle (e.g., automobile, car, truck, sport utility vehicle, motorcycle, etc.) into a personal mileage affinity club. By converting miles driven into redeemable points, the TMCS offers a marketing and promotional channel configured to appeal to a wide range of retailers and consumers. In return for creating fungibility from miles driven, each TMCS subscriber configures or sets up a personal home page on the TMCS web site. Periodically, the subscriber accepts via the TMCS web site a number of advertisement views or materials and enters into a variety of for-gain interactions, thus ensuring regular metered exposure to self-electing recipients for the TMCS vendors or retail partners.

The market class of automobile owners is an amorphous group; however the nature of the TMCS ensures that self-selection automatically occurs so that appropriate target subscribers become associated with those commercial partners (vendors) who most want to reach them. Subscribers select those vendors from whom they want to receive information and in whose stores (e.g., online, physical shopping outlet, etc.) they intend to redeem TMCS points. In contrast to generating an extensive demographic database, the TMCS uses a simple opt-in to achieve the same results. Advertisement views and other relevant actions are tracked in the TMCS so that acquisition and retention costs can be calculated and adjusted appropriately by vendors. Additionally, the TMCS provides surveys so that retail partners can, at their discretion, capture additional information about the subscribers viewing their promotions. In return the subscribers will receive additional points for completing such surveys.

The TMCS subscription model generally functions to offer a range of choices of retailers to a subscriber against whose goods and services TMCS points can be redeemed. Under the example that includes accumulated points in exchange for reported automobile mileage, points are accumulated at the rate of one point per mile, or two points per mile for hybrid vehicles, plus additional points for completing surveys, participating in certain offers, etc., for example. Redemption of points qualifies the TMCS subscriber for significant discounts established by TMCS vendors, for whom these discounts are part of their promotional budget. Discounts can range according to product category from hundreds to thousands of dollars.

As a further example, the TMCS subscription structure of an embodiment includes a minimum subscription at a first rate (e.g., $2 per month) and this permits the subscriber to redeem points against goods and services offered by one selected retail partner. By raising the subscription to a second rate (e.g., $3 per month) the subscriber can select two retail partners; a third subscription rate (e.g., $4 per month) allows three partners to be selected, and at the maximum subscription rate (e.g., $5 per month) the subscriber can redeem mileage points against a maximum of five retail partners. Subscribers will also earn points for responding to questionnaires, creating product reviews, and conducting other marketing-related activities on behalf of our retail partners. The subscription rate structure above is presented as an example only and does not limit the TMCS to any particular subscription rate structure.

Continuing, once a subscriber has selected a subscription structure and paid the corresponding fee, the subscriber activates his/her membership by submitting a validated record of his/her odometer reading so that future miles driven can accurately be determined. The TMCS provides a printable web page with fields for vehicle license plate number, registered owner, odometer reading, garage name and address, date, etc. The subscriber then takes this print-out to their local garage which for a fee (payable or reimbursable to the subscriber by TMCS) validates the mileage. The subscriber then mails in this information. The TMCS web page is also available online so that garages with an Internet connection can complete the transaction without having to use a printed form.

The mileage validation mechanism described above is repeated at such time as the subscriber wishes to redeem TMCS points. The redemption of TMCS points includes converting some or all accrued miles into goods or services from a selected retail partner(s). Point redemption includes but is not limited to direct redemption through the TMCS web site, redemption through the vendor's website, redemption via a telephone or other directed communication device, redemption at a physical vendor location, and redemption through one or more mail-in programs to name a few.

Once the subscribers have joined the TMCS, they will be encouraged to visit the TMCS website regularly to update the odometer reading on their personalized dashboard as described below. Each TMCS vendor is able to implement its own optimal frequency/reward mechanisms in line with its marketing goals. By tracking a subscriber's accrued miles on a regular basis, vendors can present the most suitable promotions and offers based on that subscriber's actual and projected future ability to redeem TMCS points. Further enticements to visit the TMCS web site regularly can be provided through mechanisms, for example, in which subscribers can trade miles against redemption choices, and by games through which accrued miles can be mapped to travel-related prizes.

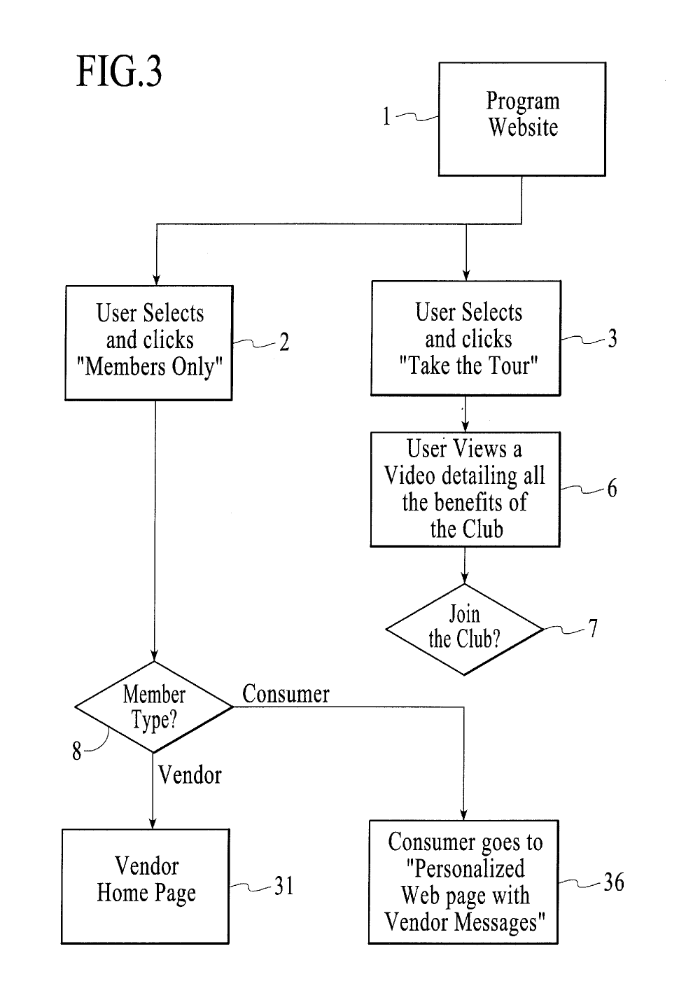

As more specific examples of operation of the TMCS of an embodiment, FIGS. 3-7 are flow diagrams showing a process, according to embodiments as described herein, that includes a TMCS web site implementing targeted marketing communication. In an embodiment, a home page of the web site and several associated pages are accessible to both consumer users and vendor users as described herein. As further described below, various pages of the web site are intended to be accessed by either subscribers or vendors.

FIG. 3 is a flow diagram showing a process implemented on a TMCS web site and involving an initial user who is also a prospective member of a club as represented by the TMCS and as described herein. From a program website, as shown at 1, a user may access a user's only section by selecting and click a “Members Only” link, as indicated a 2. The user is then queried for a user type at 8. The user, for example, may be a vendor or a subscriber, but embodiments are not so limited. If the user is a vendor, then the user is presented with a vendor home page, as designated by 31. A user who is a subscriber is presented with a personalized web page that includes vendor messages, as designated by 36.

Referring again to the program website at 1, a user may select and click a “Take the Tour” link, as shown at 3. In an embodiment, the user is presented with print, graphic, video or other information that details the benefits of membership in the club, as shown at 6. The user is then given an opportunity to join the club at 7.

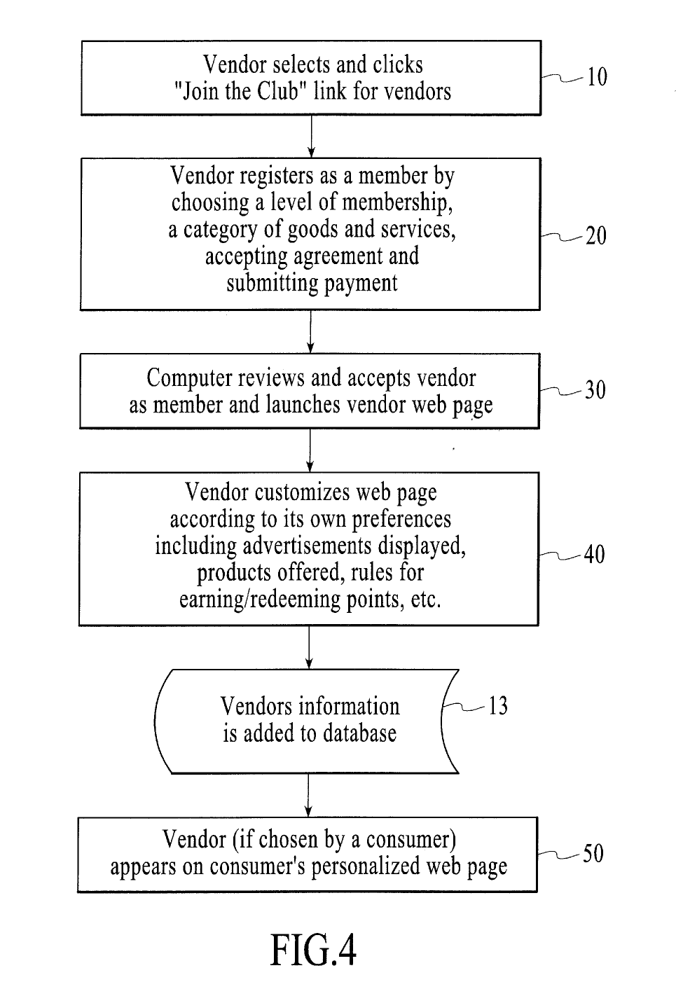

With reference to FIG. 4, an initial user who is a vendor may select and click a “Join the Club” for vendors (designated by 10) from either program website 1 or opportunity 7, for example. As shown at 20, a vendor registers by choosing a level of membership, choosing a category of goods and services, accepting an agreement, and submitting a payment for becoming a member vendor.

According to an embodiment, the transaction component (FIG. 1) reviews and accepts the vendor user as a member, and launches a vendor web page at 30. The computer may be resident anywhere on a network accessible to the vendor's computer.

At 40, the vendor user customizes the web page according to its own preferences. Customization includes specific advertisements displayed, specific products offered, rules for earning and redeeming points, etc. Vendor information related to the vendor user is entered in a database at 13. In various embodiments, the database may reside anywhere on any network, and is not necessarily collocated with the computer.

If the vendor user is then chosen by a subscriber as described herein, the vendor will appear on a subscriber personalized web site at 50 (further described below) in the form of visual or audio data as designated by the vendor.

Subscribers initially sign up via the TMCS interface and provide personal information referred to as registration data. The registration data includes one or more of name, billing address, and credit card information sufficient to complete an online transaction. Subscribers also select various levels of involvement with the site according to their personal preferences. Alternative methods of becoming a subscriber may also be supported through other media such as, but not limited to, mobile telephones and fixed telephones and in-vehicle navigation devices and other technologies as appropriate.

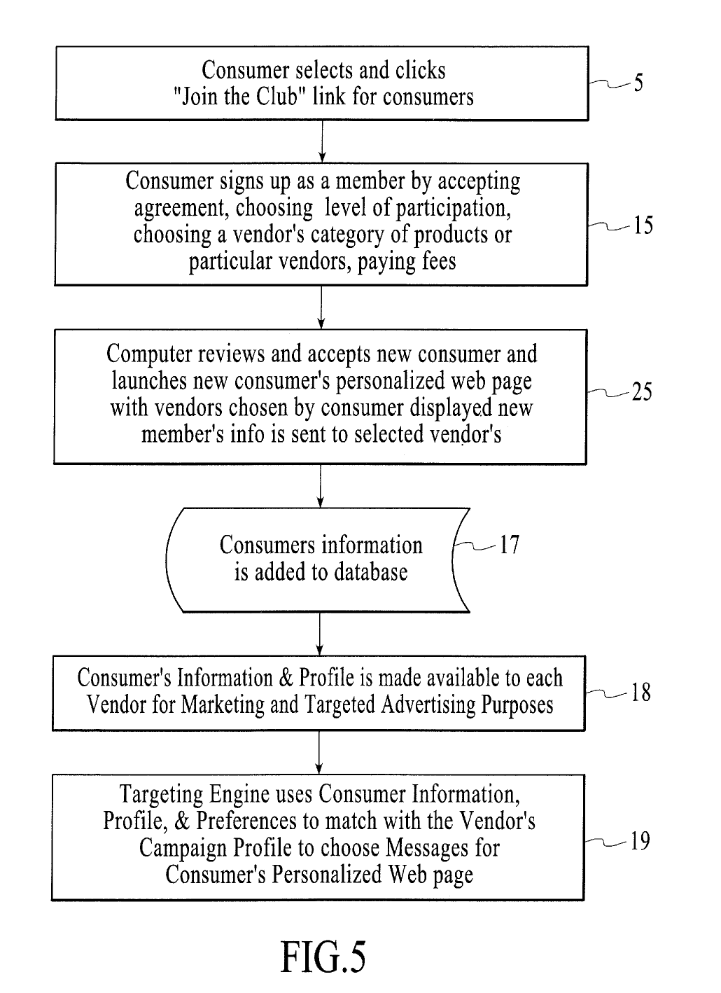

FIG. 5 is a flow diagram illustrating a process implemented on the TMCS web site and involving an initial user who is a consumer who desires to be a member or subscriber, according to an embodiment. At 5, the consumer clicks a “join the Club” link for consumers. The consumer signs up as a subscriber or consumer user by accepting an agreement, choosing a level of participation, choosing a vendor's category of products and/or choosing particular vendors, and paying fees for membership.

At 25, the computer reviews and accepts the new subscriber and launches a new subscriber's personalized web site. The personalized web site displays vendors chosen by the subscriber. The subscriber's information (as entered by the subscriber) is also sent to the selected vendors.

At 17, the subscriber's information is also added to the database. In all of the flow diagrams herein, the order of actions is not restrictive. For example, 17 could occur before, after, or concurrent with 25.

The subscriber's information and profile are made available to each selected vendor for the selected vendors' marketing and targeted advertising purposes at 18. A targeting engine that is a component of or coupled to the transaction component (FIG. 1) uses the subscriber's information, profile and preferences to match with information in a vendor's campaign profile in order to choose vendor messages to display on the subscriber's personalized web site at 19.

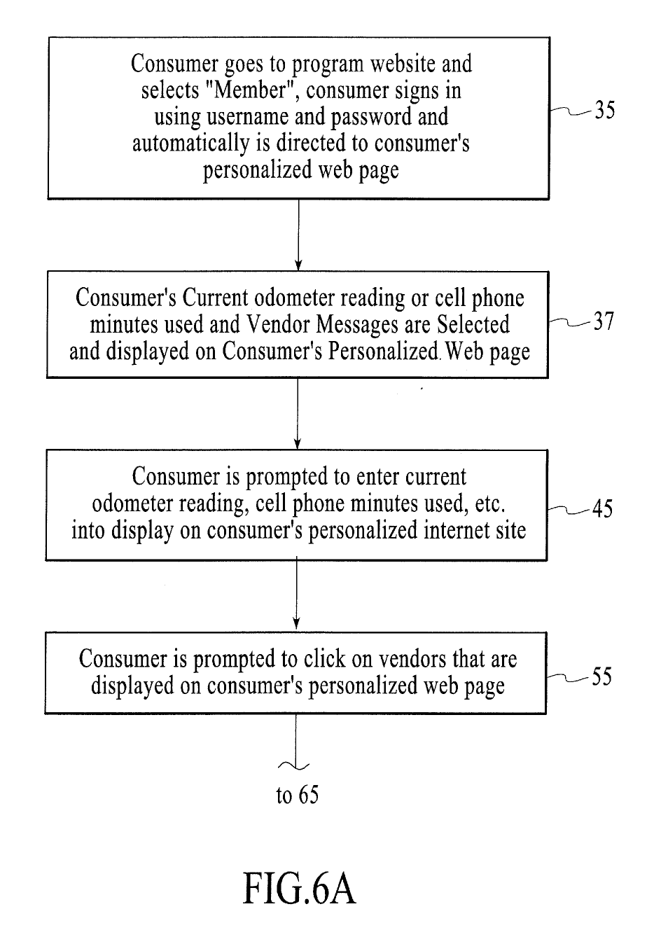

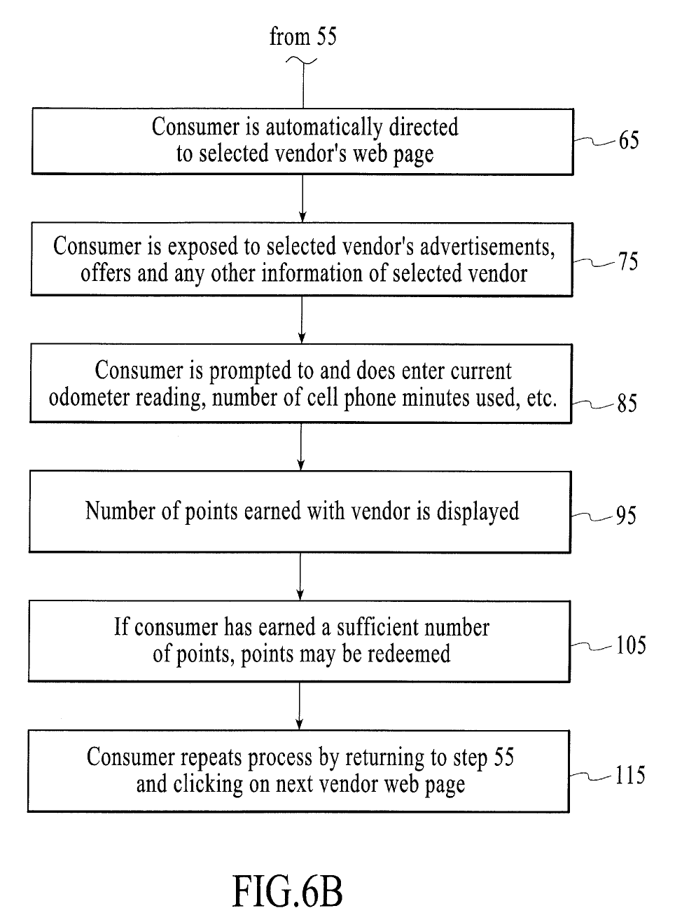

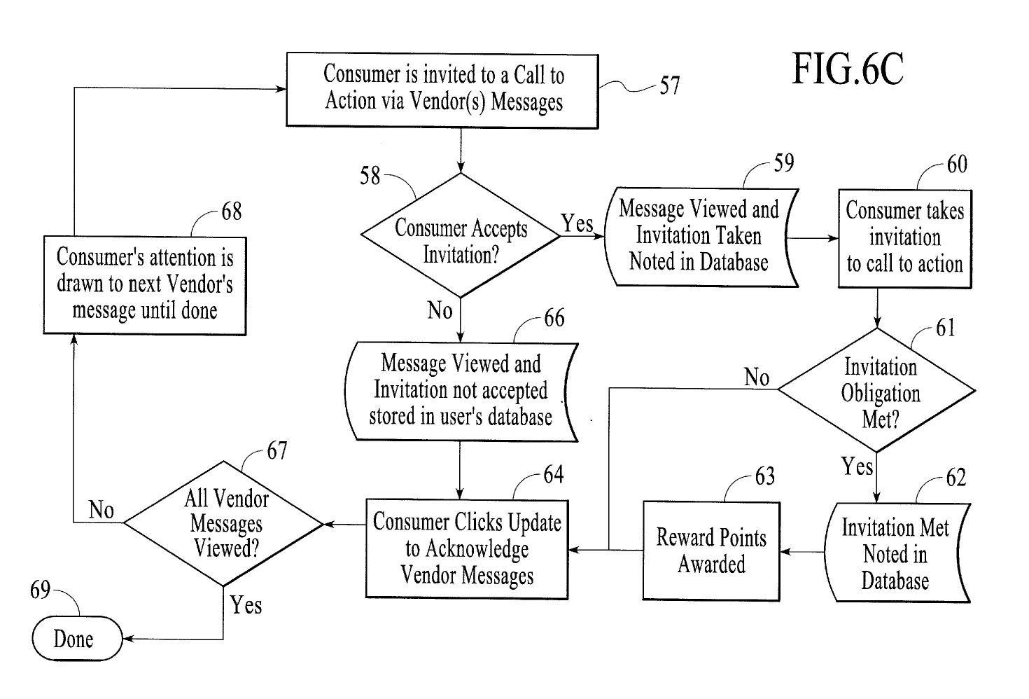

FIGS. 6A, 6B, and 6C are a flow diagram showing a process implemented on the TMCS web site and involving a subscriber, according to an embodiment. Specifically, FIGS. 6A, 6B, and 6C illustrate aspects of the user experience after the user has signed up as a subscriber. At 35, the subscriber goes to the TMCS program web site, selects “Member”, and signs in using credential that include a user name and password, but embodiments are not so limited (see also FIG. 3). At 37, the subscriber can review a current quantity of exchangeable units or activity data, such as miles (in an odometer reading) or telephone minutes as shown at 37. In various embodiments, the activity data could be many other quantifiable and verifiable items consumed by a subscriber. At 37, the subscriber can also view the vendor messages that have been selected for display on the personalized web page.

At 45, the subscriber is prompted to enter a new quantity of exchangeable units of activity data to be displayed on the subscriber's personalized web page. For example the subscriber may enter a new odometer reading or a new number of telephone minutes used. At 55, the subscriber is prompted to click on vendors that have been previously selected as described above and are now displayed on the subscriber's personalized web page.

Referring to FIG. 6B, the subscriber is automatically directed to a selected vendor's web page at 65. At 75, the subscriber is exposed to the selected vendor's advertisements, offers, and any other information of the selected vendor.

At 85, the subscriber is prompted to enter a current quantity of exchangeable units of activity data, as previously described. The subscriber enters the requested information at 85, and at 95, a number of points earned with the vendor is displayed. In an embodiment, the number of points earned is related to the quantity of activity data, as described elsewhere herein. If the subscriber has earned a sufficient number of points, the point may be redeemed, as shown at 105. As indicated at 115, the subscriber repeats the process by returning to 55 and clicking on a next vendor on the personalized web page.

With reference to FIG. 6C, more detail regarding subscriber interaction with vendor information is described. At 57, the subscriber is invited to a call to action via a vendor's message or messages. The invitation includes, for example, a special offer to buy a product or service, but embodiments are not so limited. At 58, the subscriber may accept or decline the invitation. If the invitation is accepted, at 59, a message associated with the invitation is viewed by the subscriber, and it is also noted in the database that the invitation was accepted. At 60, the subscriber accepts the invitation to the call to action. It is determined at 61 whether a user obligation associated with the invitation was met. If the obligation was met, a note is made accordingly in the database at 62. Then reward points are awarded to the subscriber at 63.

At 64, the subscriber clicks “Update” to acknowledge the vendor message, whether the obligation is met or not.

Referring again to 58, if the subscriber does not accept the invitation, a note is made in the database that the vendor message was viewed, but the invitation was not accepted. The subscriber then clicks “Update” to acknowledge the vendor message.

At 67 it is determined whether all of the vendor messages have been viewed by the subscriber. If there are unviewed messages, the subscriber's attention is drawn to the next vendor message at 68. Otherwise, this portion of the process is done as shown at 69.

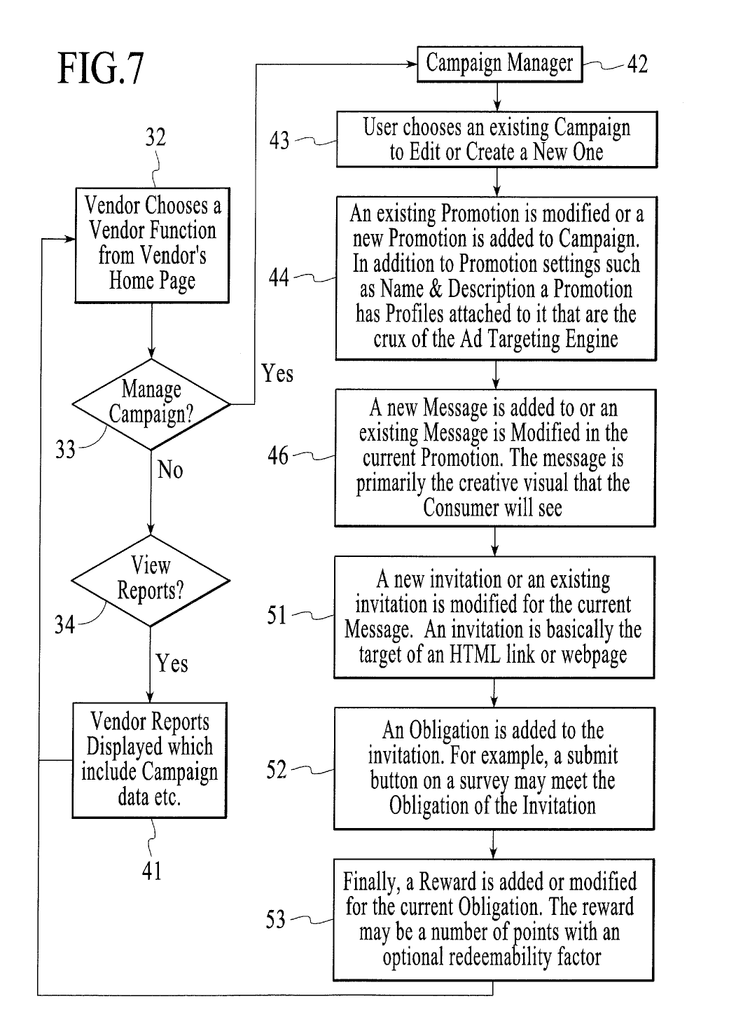

FIG. 7 is a flow diagram illustrating a process implemented on the TMCS web site and involving a vendor, according to an embodiment. Specifically, FIG. 7 illustrates aspects of the vendor experience after the vendor has signed up as a member. At 32, the vendor chooses a vendor function from the vendor's home page (Reference FIG. 3, item 31). The vendor has the option to access advertising or marketing campaign management functions, as shown at 33. If the vendor does not wish to access these management functions, the vendor user may opt to view reports, as shown at 34. If the vendor wishes to the view reports, vendor reports are displayed, including data for particular campaigns, etc., at 41.

If the vendor opts at 33 to access advertising or marketing campaign management functions, the vendor is asked whether the vendor is the campaign manager at 42. If the vendor is not the campaign manager, the vendor is not allowed access to the management function. In an embodiment, various authentication mechanisms are to authenticate a campaign manager, such as requiring a password to be entered, etc.

The TMCS as described herein is configured to allow vendors to provide information to those subscribers who have elected to include them on their personalized TMCS web pages. Such information includes but is not limited to product details and brand promotion materials and offers and discounts and customer testimonials. The purpose of all such information being supplied by the vendor to the subscriber is to enable the subscriber to develop a more complete comprehension of the range of goods and services offered by the vendor, thereby enabling the subscriber to make well-informed decisions regarding present or future purchase of goods or services from the vendor.

If the vendor is authenticated at 42, the vendor chooses an existing campaign to edit, or creates a new campaign at 43. At 44, an existing promotion can be modified or a new promotion added to the campaign. As shown at 44, promotion settings include a Name and a Description. In addition, a promotion has profiles attached to it that are part of an advertisement targeting engine.

As shown at 46, a new message can be added by the vendor, or an existing message can be modified in a current promotion. In an embodiment, the message is primarily a creative visual item that the subscriber will see. As shown at 51, the vendor can add a new invitation for the current message, and/or modify an existing invitation for the current message. In an embodiment, an invitation is a target of an HTML link or web page, but embodiments are not so limited.

As vendors learn more about individual subscribers they may elect to initiate individualized marketing programs that appeal more closely to known subscriber preferences. Therefore, the TMCS allows vendors to elect to solicit additional information from subscribers. Such information includes but is not limited to feedback on products or services offered by the vendor, suggestions concerning modifications to existing products or services offered by the vendor, suggestions concerning new products or services that subscribers believe could be offered by the vendor, and personal information about the subscriber such as income level, education level, marital status, and other demographic and consumption-relevant information as may be of interest to the vendor at any point during its participation within the TMCS. Such information is disclosed voluntarily by subscribers in return for additional points or other incentives and is obtained, transmitted, and stored in conformance with all relevant laws and statutes pertaining to the collection of such data.

At 52, the vendor can add an obligation to an invitation. As an example, clicking a submit button on a survey may meet the obligation of an invitation. At 53, the vendor can add a new reward or modify an existing reward for the current obligation. A reward may, for example, be a number of points with an optional redeemability factor, but embodiments are not so limited.

The TMCS is configured to allow subscribers to communicate with each other for a variety of purposes. These purposes include but are not limited to describing their experiences with particular participating vendors, making suggestions regarding additions and modifications to the TMCS, and offering exchanges of points in return for money or goods or services or some other tangible good whereby through such an exchange both parties derive economic or other benefit of value to both.

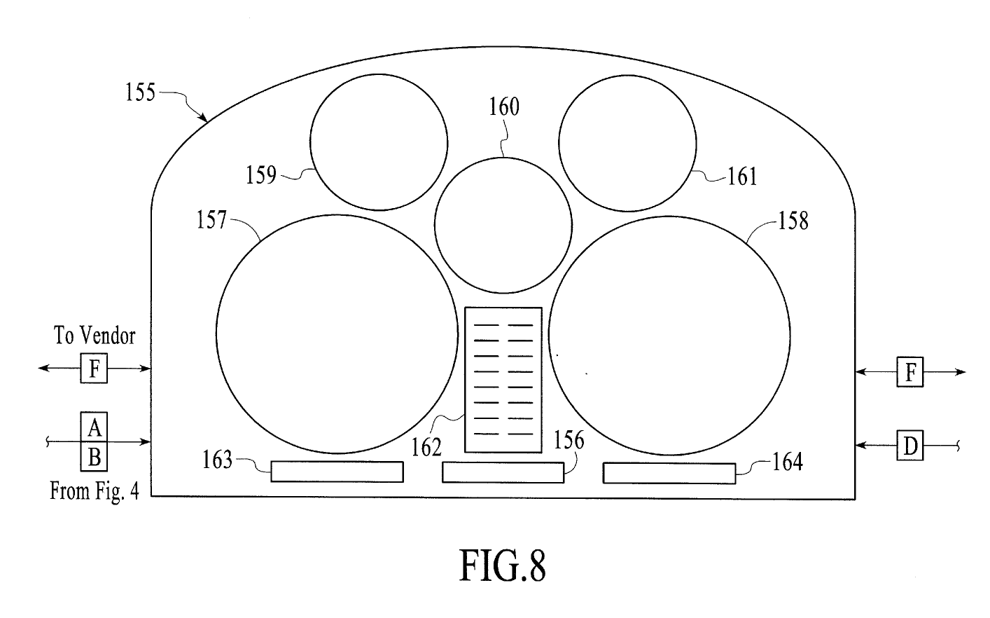

FIG. 8 is a representation of a TMCS interface 155, under an embodiment. The interface 155 as described above (FIG. 1) includes a web interface or web page but is not so limited. The interface 155 also includes a web page configured for personalization by a subscriber. This web page 155 is a representation of a dashboard including gages 157-161 and an odometer 156 configured for display on a client device. As described herein, the odometer, telephone minute usage, and/or other measurable activity data of the subscriber are entered into the odometer 156. Gage spaces 157-161 may be configured for use in displaying messages and/or may be clicked on to access a vendor's web page; the vendor's web page can be on the same website as the consumer's personalized web page or may be on another website such as a website of the vendor. Display region 162 can be configured as a display comprising a directory of vendors who have signed up and/or been accepted as preferred vendors on the TMCS web site. This display region 162 can be stepped through if there is insignificant space to display all vendors simultaneously. Display regions 163 and 164 may be message box spaces. Display region 163 for example can be configured to display messages such as prompts by which the consumer can access various vendor web pages via one of the gages 157-161. Display region 164 can be configured to display various messages including messages from the TMCS administrator with respect to various administrative matters. For example, display region 164 can be configured to prompt a consumer to pay an annual fee at the appropriate time for continued participation in the TMCS program.

The TMCS of an embodiment includes a method comprising receiving registration data of a subscriber via an interface. The registration data includes a designation of at least one vendor of a plurality of vendors. The method of an embodiment includes presenting vendor information of the at least one vendor to the subscriber via the interface. The method of an embodiment includes receiving measured activity data reported by the subscriber via the interface. The method of an embodiment includes assigning points to the measured activity and tracking the points accumulated by the subscriber. The method of an embodiment includes assigning a monetary value to the points, the monetary value corresponding to a redemption value of the at least one vendor.

Presenting vendor information under the method of an embodiment includes providing regular metered exposure to the subscriber by the vendor.

The measured activity under the method of an embodiment includes automobile mileage of the subscriber.

The measured activity under the method of an embodiment includes one or more of cellular telephone minutes and measurable recurring activity of the subscriber.

The method of an embodiment includes receiving verification of the measured activity data.

The method of an embodiment includes periodically receiving updated measured activity data.

The method of an embodiment includes assigning the points to receipt by the subscriber of a targeted communication from the at least one vendor.

The method of an embodiment includes assigning the points to interaction by the subscriber with an electronic site of the at least one vendor.

The method of an embodiment includes assigning the points to periodic visits by the subscriber to one or more of the interface, a web page of the at least one vendor, a web site of the at least one vendor, and a web page affiliated with the at least one vendor.

The method of an embodiment includes assigning the points to participation by the subscriber in an electronic activity.

The method of an embodiment includes redeeming the points for one or more of a product and a service of the at least one vendor via a transaction over the interface.

The designation under the method of an embodiment includes a selection by the subscriber of the at least one vendor from the plurality of vendors.

The vendor information under the method of an embodiment includes one or more of advertisements and directed marketing communication.

The method of an embodiment includes receiving registration data of each of the plurality of vendors.

The interface under the method of an embodiment includes a private web page of the subscriber. The private web page of an embodiment is generated for the subscriber.

The method of an embodiment includes providing an offer for one or more of goods and services to a subscriber in response to the subscriber reaching a threshold value of the measured activity data.

The method of an embodiment includes providing to the subscriber discount information of one or more of goods and services. The discount information of an embodiment is determined according to accumulated points.

The method of an embodiment includes adjusting the discount information according to fluctuations in accumulated points.

The method of an embodiment includes adjusting the discount information according to one or more of accumulated points and one or more of goods and services to which the discount information corresponds.

The method of an embodiment includes conducting an arbitrage transaction in which a first subscriber having a first number of accumulated points negotiates with a second subscriber having a second number of accumulated points.

The TMCS of an embodiment includes a system comprising a transaction component coupled to client devices of a subscriber and a plurality of vendors. The system of an embodiment includes an interface coupled to the transaction component. The interface of an embodiment is configured to transfer communications between one or more of the subscriber and the plurality of vendors. The transaction component of an embodiment is configured to receive registration data of the subscriber. The registration data of an embodiment includes a designation of at least one vendor of the plurality of vendors. The transaction component of an embodiment is configured to provide vendor information of the at least one vendor to the subscriber. The transaction component of an embodiment is configured to receive measured activity data of the subscriber. The transaction component of an embodiment is configured to assign points to the measured activity and track the points accumulated by the subscriber. The transaction component of an embodiment is configured to assign a monetary value to the points that corresponds to a redemption value of the at least one vendor.

The vendor information under the system of an embodiment includes one or more of advertisements and directed marketing communication.

The measured activity under the system of an embodiment includes one or more of automobile mileage and cellular telephone minutes of the subscriber.

The transaction component under the system of an embodiment is configured to periodically receive updated measured activity data.

The transaction component under the system of an embodiment is configured to assign the points in response to receipt by the subscriber of a targeted communication from the at least one vendor.

The transaction component under the system of an embodiment is configured to assign the points to periodic visits by the subscriber to one or more web pages affiliated with the at least one vendor.

The transaction component under the system of an embodiment is configured for transactions comprising redemption of the points for one or more of a product and a service of the at least one vendor.

The designation under the system of an embodiment includes a selection by the subscriber of the at least one vendor from the plurality of vendors.

The interface under the system of an embodiment includes a private web page of the subscriber.

The transaction component under the system of an embodiment is configured to generate an offer to a subscriber for one or more of goods and services in response to the measured activity data reaching a threshold value.

The transaction component under the system of an embodiment is configured to provide to the subscriber discount information of one or more of goods and services.

The transaction component under the system of an embodiment is configured to one or more of determine and adjust the discount information according to one or more of fluctuations in accumulated points and one or more of goods and services to which the discount information corresponds.

The transaction component under the system of an embodiment is configured to provide an arbitrage transaction in which a first subscriber having a first number of accumulated points negotiates with a second subscriber having a second number of accumulated points.

The TMCS of an embodiment includes a computer readable media including executable instructions which, when executed in a processing system, provide targeted commercial communications by receiving registration data of a subscriber via an interface. The registration data of an embodiment includes a designation of at least one vendor of a plurality of vendors. The instructions of an embodiment, when executed, cause presentation of vendor information of the at least one vendor to the subscriber via the interface. The instructions of an embodiment, when executed, receive measured activity data reported by the subscriber via the interface. The instructions of an embodiment, when executed, assign points to the measured activity and track the points accumulated by the subscriber. The instructions of an embodiment, when executed, assign a monetary value to the points. The monetary value of an embodiment corresponds to a redemption value of the at least one vendor.

Aspects of the TMCS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the TMCS include: microcontrollers with memory (such as electronically erasable programmable read-only memory (EEPROM)), embedded microprocessors, firmware, software, etc. Furthermore, aspects of the TMCS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that components of the various systems and methods disclosed herein may be described using computer aided design tools and expressed or represented, as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the TMCS is not intended to be exhaustive or to limit the systems and methods described to the precise form disclosed. While specific embodiments of, and examples for, the TMCS are described herein for illustrative purposes, various equivalent modifications are possible within the scope of other systems and methods, as those skilled in the relevant art will recognize. The teachings of the TMCS provided herein can be applied to other processing systems and methods, not only for the systems and methods described above.

The elements and acts of the various embodiments described above can be combined to provide further embodiments. These and other changes can be made to the TMCS in light of the above detailed description.

In general, in the following claims, the terms used should not be construed to limit the TMCS to the specific embodiments disclosed in the specification and the claims, but should be construed to include all systems and methods that operate under the claims. Accordingly, the TMCS is not limited by the disclosure, but instead the scope of the TMCS is to be determined entirely by the claims.

While certain aspects of the TMCS are presented below in certain claim forms, the inventor contemplates the various aspects of the TMCS in any number of claim forms. Accordingly, the inventors reserve the right to add additional claims after filing the application to pursue such additional claim forms for other aspects of the TMCS.

What is claimed is:

1. A method comprising:
receiving registration data of a subscriber via an interface, wherein the registration data includes a designation of at least one vendor of a plurality of vendors;
presenting vendor information of the at least one vendor to the subscriber via the interface;
receiving measured activity data reported by the subscriber via the interface;
assigning points to the measured activity and tracking the points accumulated by the subscriber; and
assigning a monetary value to the points, the monetary value corresponding to a redemption value of the at least one vendor.

2. The method of claim 1, wherein the presenting vendor information provides regular metered exposure to the subscriber by the vendor.

3. The method of claim 1, wherein the measured activity includes automobile mileage of the subscriber.

4. The method of claim 1, wherein the measured activity includes one or more of cellular telephone minutes and measurable recurring activity of the subscriber.

5. The method of claim 1, comprising receiving verification of the measured activity data.

6. The method of claim 1, comprising periodically receiving updated measured activity data.

7. The method of claim 1, comprising assigning the points to receipt by the subscriber of a targeted communication from the at least one vendor.

8. The method of claim 1, comprising assigning the points to interaction by the subscriber with an electronic site of the at least one vendor.

9. The method of claim 1, comprising assigning the points to periodic visits by the subscriber to one or more of the interface, a web page of the at least one vendor, a web site of the at least one vendor, and a web page affiliated with the at least one vendor.

10. The method of claim 1, comprising assigning the points to participation by the subscriber in an electronic activity.

11. The method of claim 1, comprising redeeming the points for one or more of a product and a service of the at least one vendor via a transaction over the interface.

12. The method of claim 1, wherein the designation includes a selection by the subscriber of the at least one vendor from the plurality of vendors.

13. The method of claim 1, wherein the vendor information includes one or more of advertisements and directed marketing communication.

14. The method of claim 1, comprising receiving registration data of each of the plurality of vendors.

15. The method of claim 1, wherein the interface is a private web page of the subscriber, wherein the private web page is generated for the subscriber.

16. The method of claim 1, comprising providing an offer for one or more of goods and services to a subscriber in response to the subscriber reaching a threshold value of the measured activity data.

17. The method of claim 1, comprising providing to the subscriber discount information of one or more of goods and services, wherein the discount information is determined according to accumulated points.

18. The method of claim 17, comprising adjusting the discount information according to fluctuations in accumulated points.

19. The method of claim 17, comprising adjusting the discount information according to one or more of accumulated points and one or more of goods and services to which the discount information corresponds.

20. The method of claim 1, comprising conducting an arbitrage transaction in which a first subscriber having a first number of accumulated points negotiates with a second subscriber having a second number of accumulated points.

21. A system comprising:
a transaction component coupled to client devices of a subscriber and a plurality of vendors; and
an interface coupled to the transaction component, the interface configured to transfer communications between one or more of the subscriber and the plurality of vendors, the transaction component configured to receive registration data of the subscriber, the registration data including a designation of at least one vendor of the plurality of vendors, the transaction component configured to provide vendor information of the at least one vendor to the subscriber, the transaction component configured to receive measured activity data of the subscriber, the transaction component configured to assign points to the measured activity and track the points accumulated by the subscriber, the transaction component configured to assign a monetary value to the points that corresponds to a redemption value of the at least one vendor.

22. The system of claim 21, wherein the vendor information includes one or more of advertisements and directed marketing communication.

23. The system of claim 21, wherein the measured activity includes one or more of automobile mileage and cellular telephone minutes of the subscriber.

24. The system of claim 21, wherein the transaction component is configured to periodically receive updated measured activity data.

25. The system of claim 21, wherein the transaction component is configured to assign the points in response to receipt by the subscriber of a targeted communication from the at least one vendor.

26. The system of claim 21, wherein the transaction component is configured to assign the points to periodic visits by the subscriber to one or more web pages affiliated with the at least one vendor.

27. The system of claim 21, wherein the transaction component is configured for transactions comprising redemption of the points for one or more of a product and a service of the at least one vendor.

28. The system of claim 21, wherein the designation includes a selection by the subscriber of the at least one vendor from the plurality of vendors.

29. The system of claim 21, wherein the interface includes a private web page of the subscriber.

30. The system of claim 21, wherein the transaction component is configured to generate an offer to a subscriber for one or more of goods and services in response to the measured activity data reaching a threshold value.

31. The system of claim 21, wherein the transaction component is configured to provide to the subscriber discount information of one or more of goods and services.

32. The system of claim 31, wherein the transaction component is configured to one or more of determine and adjust the discount information according to one or more of fluctuations in accumulated points and one or more of goods and services to which the discount information corresponds.

33. The system of claim 21, wherein the transaction component is configured to provide an arbitrage transaction in which a first subscriber having a first number of accumulated points negotiates with a second subscriber having a second number of accumulated points.

34. A computer readable media including executable instructions which, when executed in a processing system, provides targeted commercial communications by:
receiving registration data of a subscriber via an interface, wherein the registration data includes a designation of at least one vendor of a plurality of vendors;
presenting vendor information of the at least one vendor to the subscriber via the interface;
receiving measured activity data reported by the subscriber via the interface;
assigning points to the measured activity and tracking the points accumulated by the subscriber; and
assigning a monetary value to the points, the monetary value corresponding to a redemption value of the at least one vendor.
